(19) United States
(12) Patent Application Publication
(10) Pub. No.: US 2012/0252241 A1
(43) Pub. Date: Oct. 4, 2012

(54) Shock-proof electric outlet

(76) Inventor: Joti Projkovski, Naples, FL (US)

(21) Appl. No.: 13/065,716

(22) Filed: Mar. 29, 2011

(51) Int. Cl. H01R 13/713

(52) U.S. Cl. 439/188

(57) ABSTRACT

The inventive concept is directed to a shock-proof electrical outlet. The front of the electrical outlet has two openings to receive the prongs of a male plug. One side of the opening is the hot side while the other side is the neutral side. Below each of the openings are located two opposed switches oriented such that when the prongs of the male plug are passing through the openings they will activate the switches. The switches in turn will turn on an energize an ignition coil. As soon as the ignition coil is energized it will activate other switches which in turn will turn on the power to the two prongs of the male plug by way of interposed copper contacts. Any foreign objects inserted into any of the openings cannot energize both switches simultaneously and therefore cannot produce an electric shock to the person.

### BACKGROUND OF THE INVENTION

This invention relates to fail safe and shock-proof electrical outlets that provide power to any electrical outlet that provides electric current to an outlet.

Oftentimes, accidents occur in the home due to children inserting sharp objects into power receptacles. If the child is lucky, he or she receives only a minor shock and learns never to do that again but to only insert a proper power plug of other appliances. However, more often than not, a child or any careless person receives a severe shock, which may not only cause physical and psychological damage to the child, but may also cause physical damage to the residence.

In order to help reduce the numbers of these types of accidents in the home, a wide range of receptacle devices have been suggested and are being used. For example, the most common method of child proofing an electrical outlet is by inserting a plastic safety plug into any of the unused receptacles or outlets. Although the outlet inserts do provide protection, oftentimes the adults forget to reinsert the covers or inserts after using the outlet or lose the same to thereby expose the child again to a live outlet.

U.S. Pat. No. 7,045,723 is the latest attempt to provide a child-proof outlet. The so-called “fail safe electrical outlet” has normally open switches which are wired to a breaker and the switches are located above the upper slots that normally receive the prongs attached to the plug and located below the slots that normally receive the prongs of another lower plug. There are contact arms wired to a breaker which are located below the cover plate of the receptacle and there are normally closed position switches which are located below the lower receptacle slots. As long as no plug is inserted into any of the slots, the normally open switches are not activated. However, when a plug is inserted into any of the slots the switches will close and provide current to the inserted plug. When a foreign object, such as tweezers is inserted into both slots at the same time, the breaker will be tripped because a direct connection between both the neutral and the grounded contact arms has been made before the switches are reached. If a screw driver makes contact with any of the switch levers and either of the switch levers press the activator on the normally open switch, then the circuit between the neutral slot and the ground, or the circuit between the neutral slot and the ground is completed, the breaker is tripped. Because the breaker is tripped, a person is placed on notice that someone has inserted a foreign object into an outlet and that person must reset the breaker in order to provide power to all receptacles in the home.

### BRIEF DESCRIPTION OF THE INVENTION

The present invention is an improvement over the above described patent specification because if any foreign object is inserted into the live slots, no circuit breakers will be tripped. There are at least four push buttons that need to be activated by inserting a regular power plug into any of the outlets. The push buttons will activate an ignition coil which in turn closes switches to energize the contacts.

### BRIEF DESCRIPTION OF THE DRAWINGS

FIG. 1 illustrates the schematic of the shock-proof Receptacle;

FIG. 2 shows the top view of the plug-in receptacle;

FIG. 3 illustrates the receptacle with its schematic in an open state;

FIG. 4 shows a regular power plug with its prongs being inserted into a receptacle.

FIGS. 5 and 6 show various foreign objects being inserted into the receptacle and the reaction thereto.

### DETAILED DESCRIPTION OF THE INVENTION

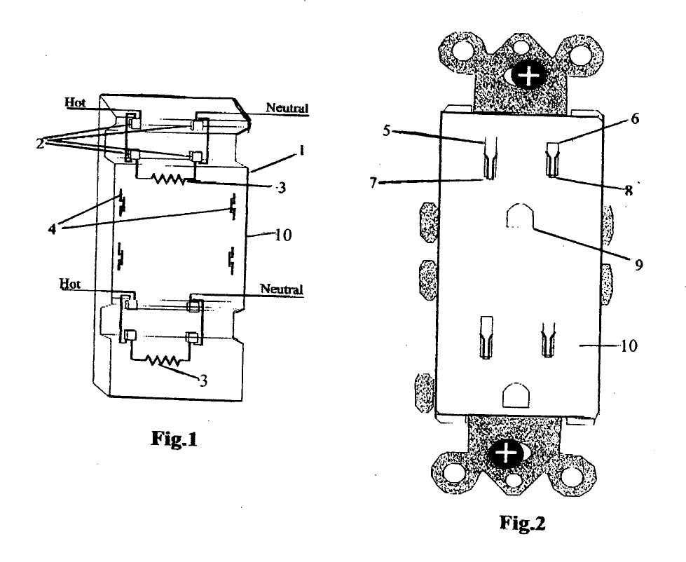

FIG. 1 shows the basic relay at 1 and at 2 are shown push buttons the will activated by each of the studs of an electric power plug that is being inserted into the electric receptacle. The push buttons 2 are each connected to ignition coils 3 which in turn are connected to switches 4. As is well known in art of electric currents, all receptacles in any voltage system receive one wire being neutral and the other wire being hot. In addition, in most instances there is a third wire representing the ground which has its own prong to be inserted into the receptacle.

FIG. 2 shows this ground connection at 9. FIG. 2 also shows the opening 5 for the hot side of the receptacle and 6 represents the neutral side of the receptacle. There is copper contact 7 on the hot side of the receptacle and there is copper contact 8 on the neutral side of the receptacle.

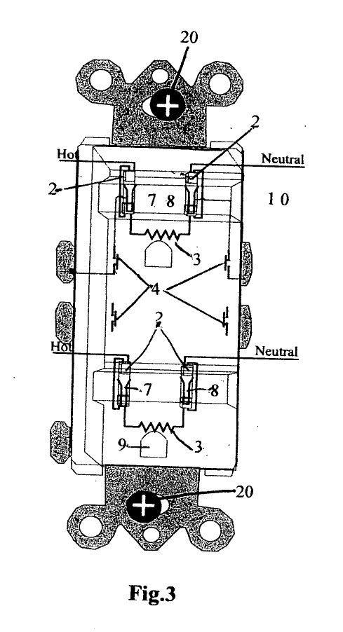

FIG. 3 illustrates the schematic of the inside of a receptacle. Within the receptacle 10 below each the openings of the prongs there located pushbuttons 2 which, when activated by the prongs of the power plug will energize the ignition coil 3 which in turn will close the switches 4. The switches 4, when closed, establish a power circuit to the copper contacts 7 and 8 and the inserted power plug is being energized by way of the copper contacts. It should be noted that the push buttons 2 slide upside down and that is how they make contact. The ends of the prongs of the male plug are unique in shape. That is, they are chamfered to present beveled surfaces, as is well known, and the bevels will cam the switches 2 into action. Also shown in FIG. 3 are the screws 20 that fasten the electrical insert 10 into the receptacle box.

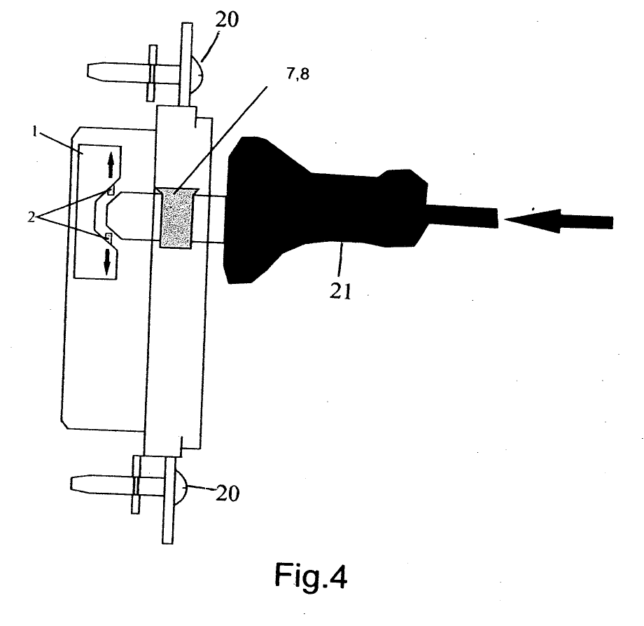

FIG. 4 illustrates a side view of the receptacles of FIGS. 1-3. Again the screws 20 fasten the electrical insert in the receptacle box (not shown). The male plug 21 has two prongs which make contact with the copper contacts 7 and 8 when inserted into their respective openings of the electrical receptacle. The two beveled ends 11 and 12 can be seen at the end of the prongs of the male plug and they are instrumental in activating the two switches 2 of the receptacle 1, as was explained above with regard to FIG. 3.

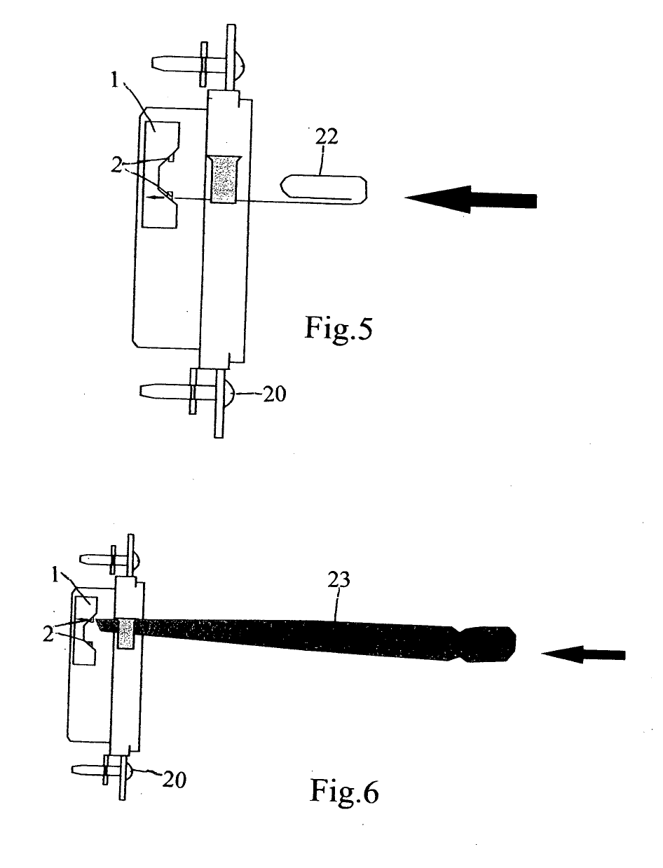

FIGS. 5 and 6 represent instances when a foreign object is being inserted into any of the openings of the electrical receptacle. FIG. 5, for examples shows a paper clip 22 being inserted and as can be seen only one of the switches 2 can be activated. As was explained above, this inventive concept requires both switches to be activated in order to energize any of the switches 4 and thereby close the main full power circuit to the receptacle and thereby to the male plug. Since this is not happening, the person (a child) pushing a paper clip into the opening cannot receive a shock.

FIG. 6 illustrates the same principle. In this illustration a pair of tweezers 23 is being inserted. Again, only one of the switches 2 can be activated and, therefore, no electric circuit can be established.

It is to be understood that while a certain form of the invention has been illustrated, it is not to be limited to the specific form or arrangement of parts herein described and shown. It will be apparent to those skilled in this art that various changes can be made without departing from the scope of the invention and the invention is not to be considered limited to what is shown and described in the specification and the drawings.

Having thus described the invention I claim:

1. A shock-proof electrical outlet comprising:
openings for a male plug having prongs thereon, one of said openings being a hot side of said receptacle and another side of said being a neutral side of said receptacle, at least two switches being located below each of said openings, at least two of said switches on the hot side being connected to an ignition coil and at least two other switches on the neutral side being connect to said ignition coil, said ignition coil, when energized by their respective switches, will operate to activate connecting switches which will connect power to said prongs on said male plug.

2. The shock proof electrical outlet of claim 1 including copper contacts interposed between said respective switches and said prongs.

3. The shock-proof electrical outlet of claim 1, wherein ends of said prongs on said male plug are beveled to assist in activating said at least two switches.

4. The shock-proof electrical outlet of claim 1, wherein at least two of said switches have to be activated to energize said coils.
